(19) United States
(12) Patent Application Publication
(10) Pub. No.: US 2026/0225872 A1
(43) Pub. Date: Aug. 6, 2026

(54) DEVICE FOR DISPENSING BEVERAGES

(71) Applicant: SPRIZZER SRL, Treviso (IT)

(72) Inventors: Gianluca MARCASSA, Treviso (IT); Matteo CALANDRIELLO, Granarolo dell'Emilia (IT)

(21) Appl. No.: 19/153,327

(22) PCT Filed: Feb. 13, 2024
(86) PCT No.: PCT/IB2024/051334

§ 371 Date: Aug. 3, 2025

(30) Foreign Application Priority Data
Feb. 13, 2023 (IT) 102023000002430

(51) Int. Cl. B67D 3/00

(52) U.S. Cl. CPC B67D 3/0016; B67D 3/0067; B67D 3/0083

(57) ABSTRACT

A device for dispensing beverages, particularly drinks or cocktails, comprises a supporting base (2) adapted to be positioned on a support surface, a plurality of reservoirs (4, 5, 6) adapted to contain respective liquids to be used for the composition of the beverage, means for dispensing liquids from each of said reservoirs (4, 5, 6), said dispensing means being suitable for allowing the dispensing of predetermined amounts of liquids from each of said reservoirs

### TECHNICAL FIELD

The present invention falls within the technical field of devices for food use, suitable for use both in the home and in public or community places, and particularly relates with a device for dispensing beverages, in particular beverages obtained following extemporaneous mixing of multiple liquid ingredients, such as cocktails, drinks and similar.

### STATE OF THE ART

As known, the extemporaneous execution of cocktails and drinks by mixing multiple liquid ingredients is apparently a very simple action, as it usually requires pouring various products from their respective containers or bottles into a common container, for example a glass, and their subsequent mixing.

On the contrary, however, to obtain a beverages with the right flavor and made according to what are sometimes well-defined standards, considerable expertise is required which is not always the prerogative of whoever creates the drink, be it a bartender or a person who decides to prepare the drink at home or in any case in a non-professional context.

As matter of fact, in the absence of auxiliary containers that allow a precise measurement of the various amounts of the individual drinks to be mixed, the proportioning of the various ingredients is always left to the greater or lesser experience of the operator, with the consequence of having drinks that are not always of constant quality, even if carried out by the same operator, no matter how expert he was.

Furthermore, especially in a commercial context wherein the time of supplying the drink has to be necessarily limited, it is not always possible to use measuring tools, which would make the preparation longer and more cumbersome.

The Italian patent 102012902029735 describes a fluid mixing device for the production of beverages which involves the use of three reservoirs for respective liquid ingredients, each of which is connected to a dispensing duct of the respective ingredient.

A pressing element simultaneously crushes the ducts to obtain a controlled and simultaneous dispensing of the liquids, which will be dispensed simultaneously and according to predetermined doses into a single container or glass.

This solution, while allowing the beverages to be obtained quickly and with doses that are always regulated and substantially constant, has nevertheless proven to be improvable.

In particular, there is a felt need for quicker and more convenient management of the reservoirs.

Furthermore, the particular configuration of the pressing element, equipped with multiple dispensing levers, does not allow the liquids to always be dispensed in the right proportions.

Furthermore, the pressing element is made up of various elements assembled together and involves the use of two levers, with a consequent decrease in reliability linked to the presence of a relatively high number of components and therefore a greater risk of breakages or malfunctions.

Last but not least, there is also a need for a dispensing device that allows the recipe to be modified, with the same ingredients, usually defined on the basis of the technical characteristics of the device itself and not modifiable by the user.

### SCOPE OF THE INVENTION

The object of the present invention is to overcome the above drawbacks by providing a device for dispensing beverages, in particular drinks or cocktails, which is characterized by high efficiency and relative cost-effectiveness.

A particular object is to provide a device for dispensing mixed beverages, in particular drinks or cocktails, which allows a controlled and precise dosage of the mixture of liquids used to make the drink or cocktail.

Yet another object is to provide a device for dispensing mixed beverages, in particular drinks or cocktails, which allows the liquids to always be dispensed in the right quantities and proportions, to be used even by people not specialized in the preparation of drinks.

Yet another object is to provide a device for dispensing mixed beverages, in particular drinks or cocktails, which also allows the amounts of one or more liquids to be modified, always in a controlled manner, to vary the recipe.

Yet another object is to provide a device for dispensing mixed beverages, in particular drinks or cocktails, which allows quicker and simpler management of the reservoirs both in the filling/emptying phases and in their cleaning.

Not the least object is to provide a device for dispensing mixed beverages, in particular drinks or cocktails, characterized by greater simplicity in construction and therefore also greater reliability.

These objects, as well as others that will become more apparent hereinafter, are obtained by a device for dispensing beverages, in particular drinks or cocktails, according to claim 1, to which reference is made for greater conciseness of the explanation.

The device so realized will allow the recipe to always be carried out by dispensing precise doses and in a controlled manner, even by a non-specialist user, representing a tool that can be used in both professional and non-professional environments, including at home.

Advantageously, the device will also allow the dispensed quantities of each liquid to be varied to allow the recipe to be modified and adapted to the specific needs or type of liquids.

Conveniently, regardless of the shape of the reservoir, a device for dispensing beverages, in particular drinks or cocktails, may comprise a supporting base adapted to be positioned on a support surface, a plurality of reservoirs suitable for containing respective liquids to be sued for the composition of the drink, means for dispensing liquids from each of said reservoirs, said dispensing means being suitable for allowing the dispensing of predetermined amounts of liquids from each of said reservoirs and further comprising an actuator suitable for acting on all said ducts to locally reduce the section thereof and control the dispensing of liquids therefrom, wherein said actuator will also comprise an operating lever integral with a compression element having a cylindrical body on which a plurality of cams are made in a number equal to said dispensing ducts and made in a monolithic manner so that each of them operates, directly or indirectly, on a corresponding duct to locally vary its section following the axial rotation imposed on said cylindrical body by said operating lever.

The structure of the actuator will thus be particularly compact and composed of a reduced number of elements which will considerably increase both its reliability and ease of assembly and use.

Furthermore, the reservoirs may be integral with each other and contained in a common housing placed on the top of said supporting base in a removable manner.

Thanks to this combination of features, it will be possible to have a more compact and more easily manageable structure, both in the cleaning and filling phases of the various reservoirs.

Particularly advantageous alternative embodiments of the device are obtained in accordance with the dependent claims.

### BRIEF DISCLOSURE OF THE DRAWINGS

Further features and advantages of the object of the invention will become more apparent in light of the detailed description of some preferred but not exclusive embodiments of the device according to the invention, shown by way of non-limiting example with the aid of the attached drawing tables wherein:

FIG. 1 is a perspective view of the assembled device;

FIG. 2 is a front view of the device of FIG. 1;

FIG. 3 is an exploded perspective view of the device of FIG. 1;

FIG. 4 is a perspective view of the reservoir assembly belonging to the device of FIG. 1, having the delivery ducts;

FIG. 5 is a perspective view of the reservoir assembly in a second variant;

FIG. 6 is an exploded perspective view of the reservoir assembly of FIG. 5;

FIGS. 7 and 8 are two views of a first detail of the actuator belonging to the device according to two different embodiments;

FIG. 9 is an exploded perspective view of a detail of the device showing the actuator and the relative support block;

FIG. 10 is an assembled perspective view of the detail of FIG. 9 in the closed condition of the ducts;

FIG. 11 is an assembled perspective view of the detail of FIG. 9 in the open condition of the ducts;

FIG. 12 is a sectional perspective view of the detail of FIG. 10;

FIG. 13 is a sectional perspective view of the detail of FIG. 11;

FIG. 14 is a further perspective sectional view of the detail of FIG. 9;

FIG. 15 is an exploded perspective view of the detail of FIG. 9 according to a further variant;

FIG. 16 is an exploded perspective view and partial section of a part of a device in a second variant;

FIG. 17 is a further exploded perspective view and partial section of the device of FIG. 16.

### BEST MODES OF CARRYING OUT THE INVENTION

With reference to the attached figures, some preferred but not exclusive embodiments of a device for dispensing mixed beverages are shown, suitable for use both in the home and in public or community places for the extemporaneous production of mixed drinks, such as drinks or cocktails.

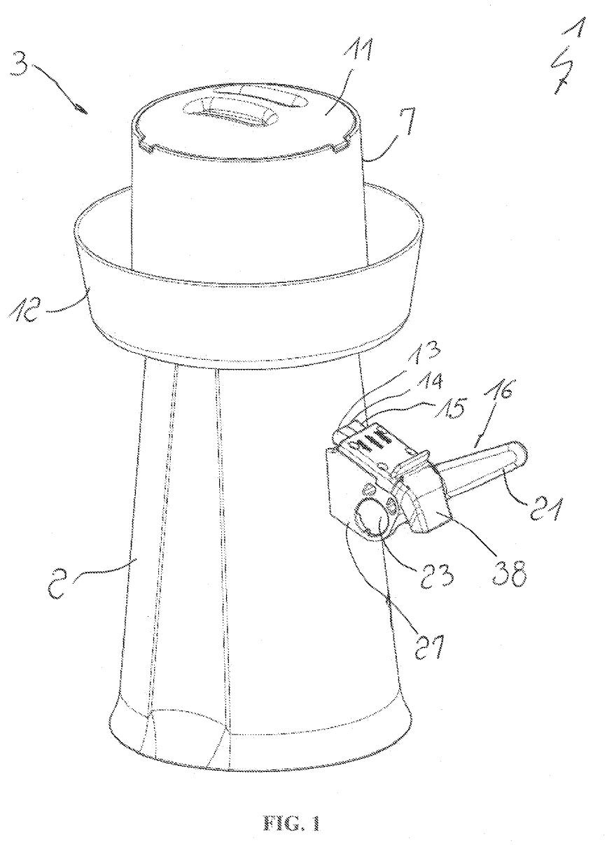

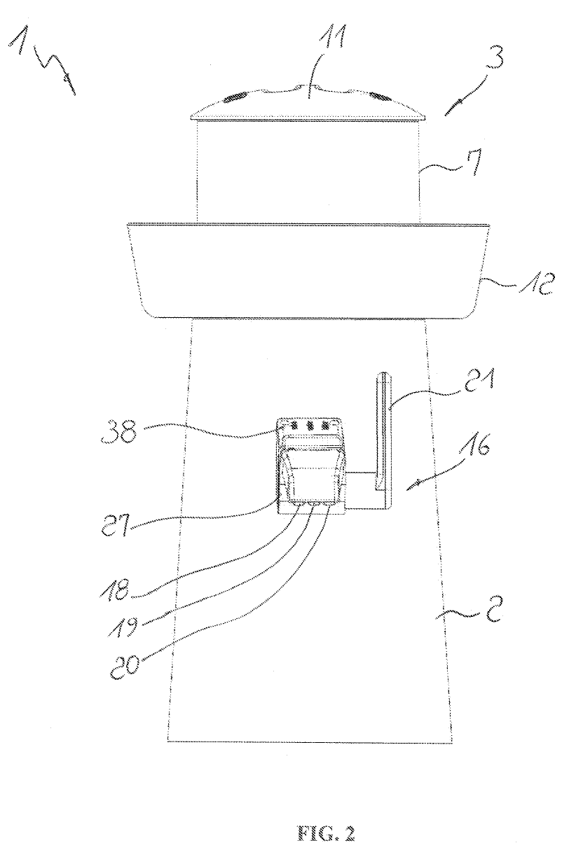

In its basic version of FIG. 1, the device, globally referred as 1, firstly comprises a supporting base 2 adapted to be positioned on a support surface, generally flat and horizontal.

The supporting base 2, with a truncated cone shape in the figures but which can have any shape, may be sized in width and height depending on the needs and availability of space, and may be either solid or hollow.

A reservoir group 3 designed to contain the liquids required for the specific recipe is placed on the top of the supporting base 2.

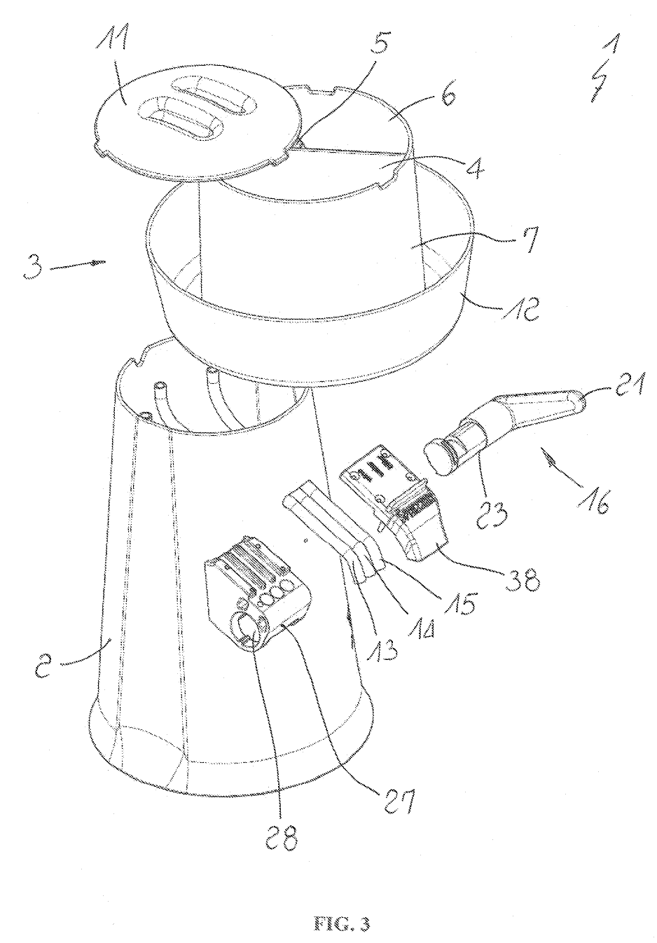

According to a preferred version and as more clearly visible from FIG. 3, the reservoir group 3 is made up of three reservoirs 4, 5, 6 suitable for containing respective liquids to be used for the composition of the drink.

Although the figures illustrate a device 1 suitable for dispensing three liquids, for example for the preparation of a long drink such as a spritz, each of which is intended to be contained in a respective of the three reservoirs 4, 5, 6, it is understood that it will also be possible to provide configurations suitable for use with only two liquids or with more than three liquids, thus providing only two reservoirs or more than three reservoirs.

Furthermore, it is also understood that the type of liquids to be used does not represent a limitation for the present invention, as the use of liquids of any type can be foreseen, not necessarily different from each other, as their choice will depend exclusively on the needs of the user.

Conveniently, the reservoirs 4, 5, 6 will be integral with each other and contained in a common central container 7 applied to the top of the supporting base 2.

Preferably, the reservoirs 4, 5, 6 will be applied to the supporting base 2 in a removable manner to be removed and repositioned in a unitary manner.

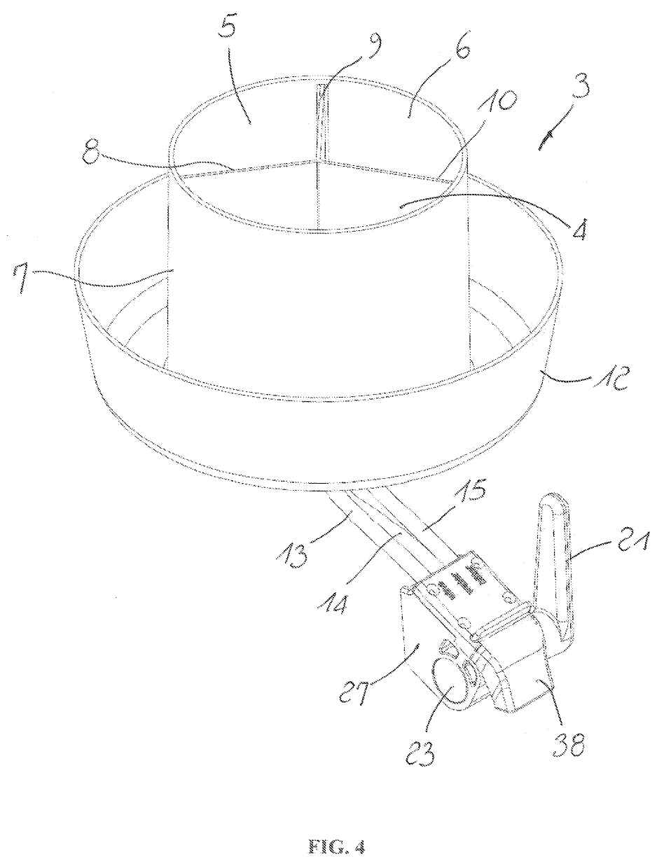

Even more preferably, although not essential and non-limiting for the present invention, the reservoirs 4, 5, 6 will be defined by the division of the central container 7 into three parts by means of three partitions 8, 9, 10, as more clearly visible from FIG. 4.

In the illustrated configuration, preferred but not exclusive, the central container 7 has a cylindrical shape and the partitions 8, 9, 10 extend in a radial direction from a central area to divide the central container 7 into the three reservoirs 4, 5, 6, which will not necessarily have the same capacity but which can be appropriately proportioned according to the quantities of the respective liquid to be contained, which varies depending on the drink to be obtained.

According to a preferred but not exclusive embodiment, the reservoirs 4, 5, 6 may have respective internal capacities proportioned in a manner corresponding to the proportions with which the respective liquids become part of the specific recipe so that the liquids end at the same time after supplying a predefined number of drinks.

According to a variant not shown, the partitions 8, 9, 10 may be movable to allow the adjustment of the individual capacities of the three reservoirs 4, 5, 6.

The central container 7 may also be provided with a removable upper lid 11 which will allow all the reservoirs 4, 5, 6 to be closed in a unitary manner.

The reservoir group 3 also comprises a base container 12 provided inside with the above central container 7 placed in a substantially central position.

In the illustrated configuration, the base container 12 has a substantially cylindrical or truncated cone shape and an annular radial section, with a lower base of a width greater than that of the central container 7 and a height lower than the same, developing around the perimeter of the entire central container 7.

Furthermore, the base container 12 is open at the top to allow the insertion of ice or other cooling material.

It is understood that configurations different from those illustrated may be adopted for both the base container 12 and the central container 7.

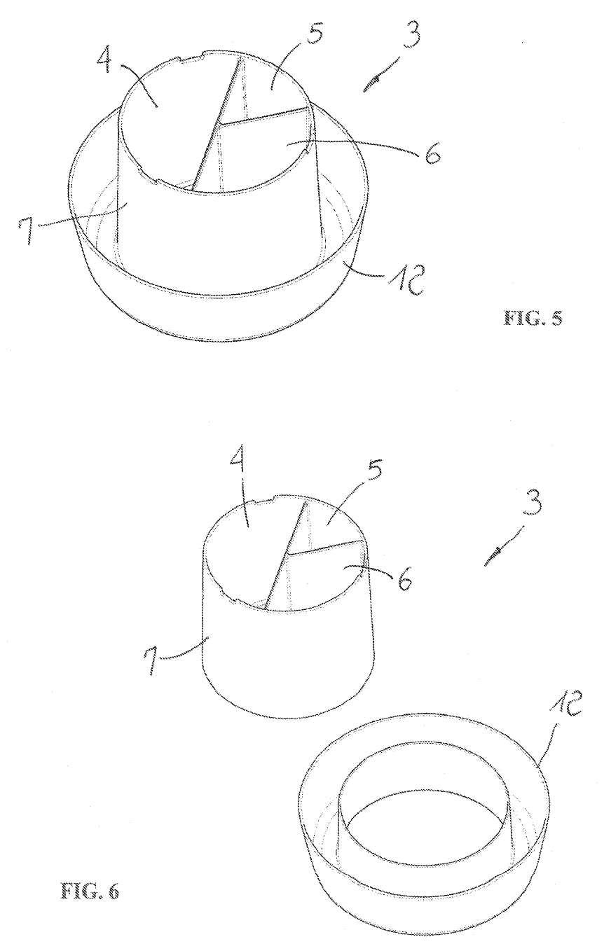

FIG. 5 shows a second variant of the reservoirs group 3 which differs from the previous one in that the central container 7 and the base container 12 are separable, as also visible in FIG. 6. This configuration will allow for easier emptying the base container 12 from the ice and/or the water accumulated following the melting of the ice.

Each reservoir 4, 5, 6 is also provided with means for dispensing the respective liquids and which will be suitable for allowing the simultaneous dispensing of predetermined amounts of liquids from each of them.

As visible from FIG. 4, each reservoir 4, 5, 6 will have a respective delivery duct 13, 14, 15 of the liquid preferably defined by a flexible tube and made of deformable or compressible material.

Conveniently, the delivery ducts 13, 14, 15 will be made of respective food grade polymeric materials and with properties making them suitable to be compressed to locally reduce their section but return to the initial configuration once the compressive stress has ceased. By way of example, the material could be silicone.

Preferably, the delivery ducts 13, 14, 15 will be located mainly inside the supporting base 2, which will therefore be at least partly hollow, and will protrude from it only by their respective end sections.

The dispensing means also include an actuator 16 suitable or acting on all the dispensing ducts 13, 14, 15 to locally throttle their section, exerting the above compressive stress, and thus controlling the dispensing of the liquids therefrom through the respective outlet sections.

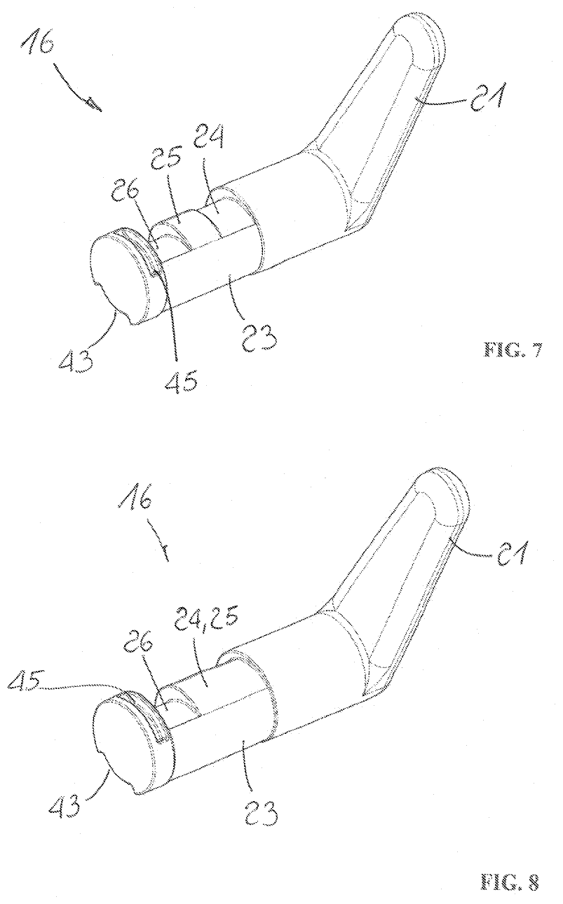

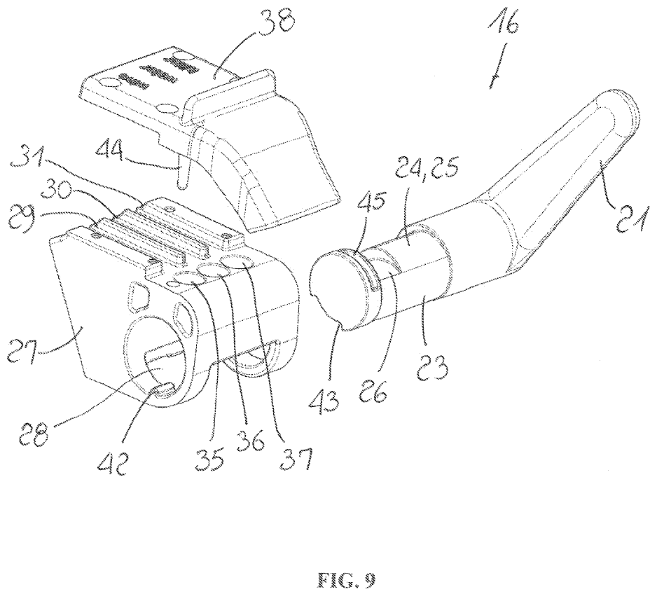

FIGS. 7 and 8 show two possible configurations, preferred but not exclusive, of the actuator 16.

In both configurations the actuator 16 is provided with an operating lever 21 integral with a cylindrical body 23 on which a plurality of cams 24, 25, 26 are made, in a number equal to that of the delivery ducts 13, 14, 15.

Preferably, the cams 24, 25, 26 will be monolithic with each other and obtained on the same cylindrical body 23, to operate, directly or indirectly, on corresponding delivery ducts 13, 14, 15 and locally vary their section upon the axial rotation imposed on the cylindrical body 23 by the operating lever 21.

The profiles of the cams 24, 25, 26 will be suitably sized and oriented reciprocally on the cylindrical body 23 depending on the flow rates desired for each liquid, which will depend on the drink to be prepared.

In particular, if it is desired to have a differentiated delivery of liquids, since each of them must be present in a different amount in the final drink, the external profiles of the cams 24, 25, 26 must be different.

In this case, the cams 24, 25, 26 will have respective outer profiles having curved compression surfaces and with differentiated curvature radii.

FIG. 8 shows a variant in which two of the three cams 24, 25, 26 have a common outer profile to define a single body.

According to yet a further variant, the operating lever 21 may have a single cam with a single profile and in this case the differentiation between the output flows of the individual delivery ducts 13, 14, 15 may be obtained by different adjustments means which will modify the flow exiting each delivery duct 13, 14, 15, as will be described more clearly below according to a possible alternative configuration.

Furthermore, according to a different variant, it will also be possible to provide delivery ducts 13, 14, 15 having different outlet sections.

Moreover, the cams 24, 25, 26 may also be sized to produce a non-synchronous opening of the relative delivery ducts 13, 14, 15, so that the liquids may come out in a non-simultaneous manner or, upon a partial rotation of the operating lever 21, one or more delivery ducts may remain closed.

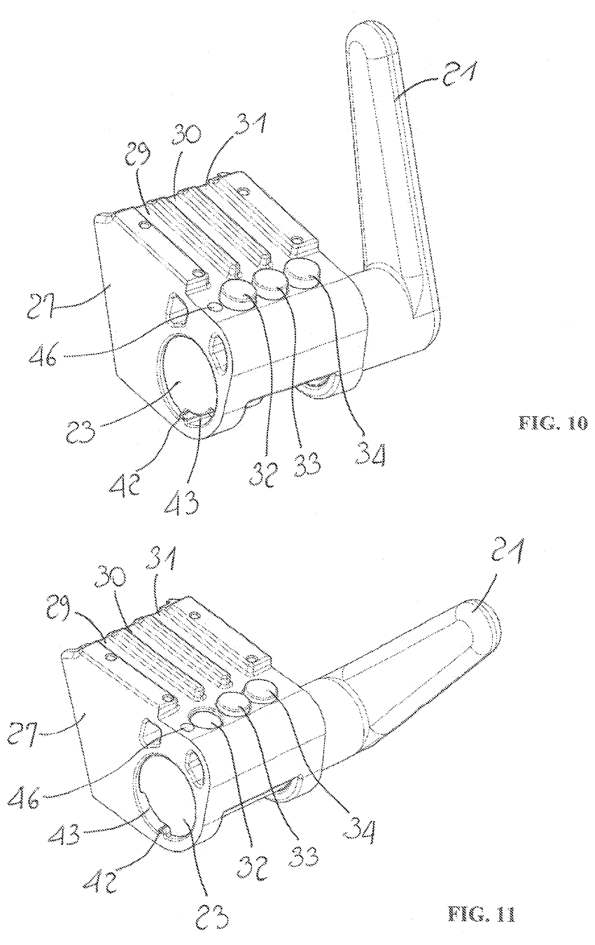

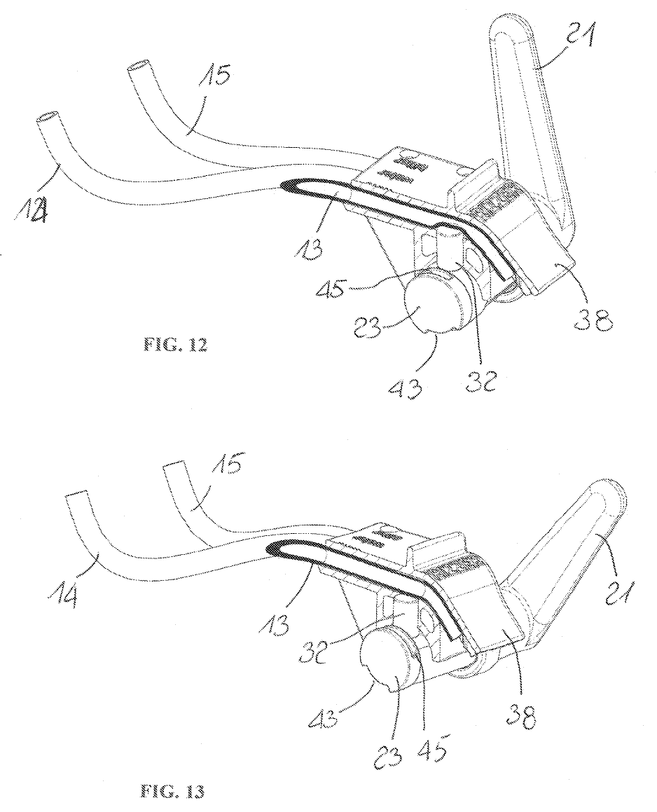

Preferably, the operating lever 21 will be adapted to rotate from a starting position of throttling or complete closure of all the delivery ducts 13, 14, 15, shown in FIGS. 10 and 12, to a final position rotated with maximum rotation angle in which all the delivery ducts 13, 14, 15 are open and with a maximum opening section, as shown in FIGS. 11 and 13.

The cylindrical body 23 with the respective cams 24, 25, 26 will be housed in a support block 27 having a cylindrical housing 28 for the cylindrical body 23 and the related cams 24, 25, 26.

The cylindrical body 23 will be positioned in the cylindrical housing 28 in a rotatable manner around its central rotation axis A and preferably will be locked in the axial direction.

The support block 27 also has three through holes 35, 36, 37 facing respective cams 24, 25, 26 and having a direction substantially orthogonal to the axis of rotation of the cylindrical body 23.

In the through holes 29, 30, 31 there will be inserted respective pistons 32, 33, 34 sized to protrude at least partially from the respective through holes 35, 36, 37 and engage with one end a respective cam 24, 25, 26 and with the other end a corresponding delivery duct 13, 14, 15 to obtain partial or complete throttling, depending on the rotation imparted to the operating lever 21.

As matter of fact, the action of the cams 24, 25, 26 on the respective pistons 32, 33, 34 will allow the section of the delivery ducts 13, 14, 15 to be locally varied to obtain the closing effect, with consequent interruption of the flow, and opening, with consequent delivery of the flow.

The support block 27 also has first housing channels 29, 30, 31 for respective end sections of the delivery ducts 13, 14, 15.

A closing cover 38 will be applied above the support block 27 to keep the end sections fixed and act as an abutment for the action of the pistons 32, 33, 34.

The closing cover 38 will also be provided with respective second housing channels 39, 40, 41 which will cooperate with the first housing channels 29, 30, 31 to create respective seats for stable housing of the end sections of the delivery ducts 13, 14, 15. According to a first variant, not shown, it will be possible to provide a drink dispensing device having the above actuator 16 complete with support block 27, operating lever 21 with cylindrical body 23 and cams 24, 25, 26, with possible pistons 32, 33, 34, and closing cover 38, in which the reservoirs 4, 5, 6 will be integral with each other and contained in a common container 7 applied to the top of the supporting base 2 in a non-removable manner.

According to yet a further variant, also not shown, it will be possible to provide a drink dispensing device provided with the above actuator 16 complete with support block 27, operating lever 21 with cylindrical body 23 and cams 24, 25, 26, with possible pistons 32, 33, 34 and closing cover 38, in which the reservoirs 4, 5, 6 will be separated from each other, for example in a similar way to what is illustrated in the cited Italian patent 102012902029735, and which can be applied to the supporting base 2 in a fixed or removable manner.

In both the two variants the advantage already highlighted of having the cams 24, 25, 26 made on a single cylindrical body 23 will be obtained.

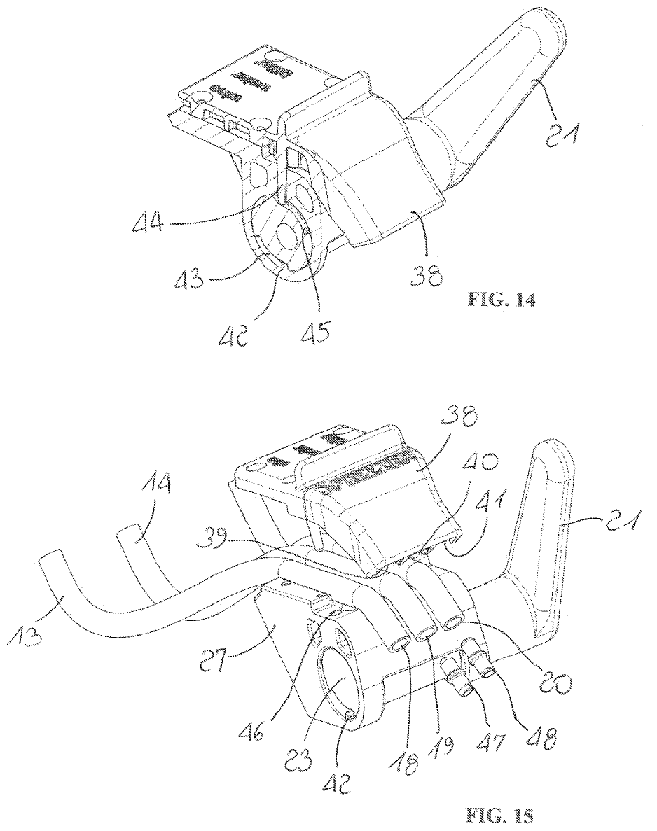

FIG. 14 then shows a further detail of the actuator 16 and the operating lever 21, from which it could be observed the presence of a tooth 42 in the support block 27 which corresponds to a first axial groove 43 in the cylindrical body 23 for blocking the rotation of the operating lever 21 between the completely open position and the completely closed position.

Furthermore, a pin 44 extends from the closing cover 38 and operates on a second axial groove 45 made in the cylindrical body 23 and which also operates as a block of the actuator 16 between the two positions of complete opening and complete closure, blocking the rotation of the cams.

Furthermore, the pin 44 fits into the hole 46 made in the support block 27 and visible in FIG. 15, to simplify the assembly of the closing cover 38 on the support block 27. In the same FIG. 15 a possible further variant is illustrated wherein the device 1 is provided with adjusting means which comprise two flow regulators or shutters 47, 48. The two shutters 47, 48 are suitable for being inserted inside respective delivery ducts 14, 15 to locally vary the liquid passage section and reduce the outgoing flow.

Preferably, the shutters 47, 48 are tubular elements designed to be inserted into respective delivery ducts 14, 15, at the respective outlet sections 19, 20, to reduce them and reduce the flow rate of the corresponding flow.

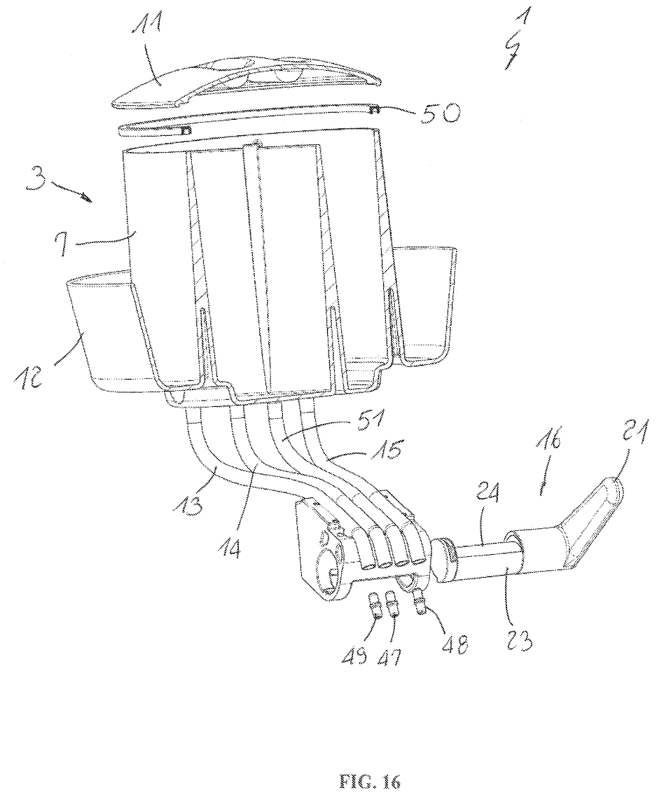

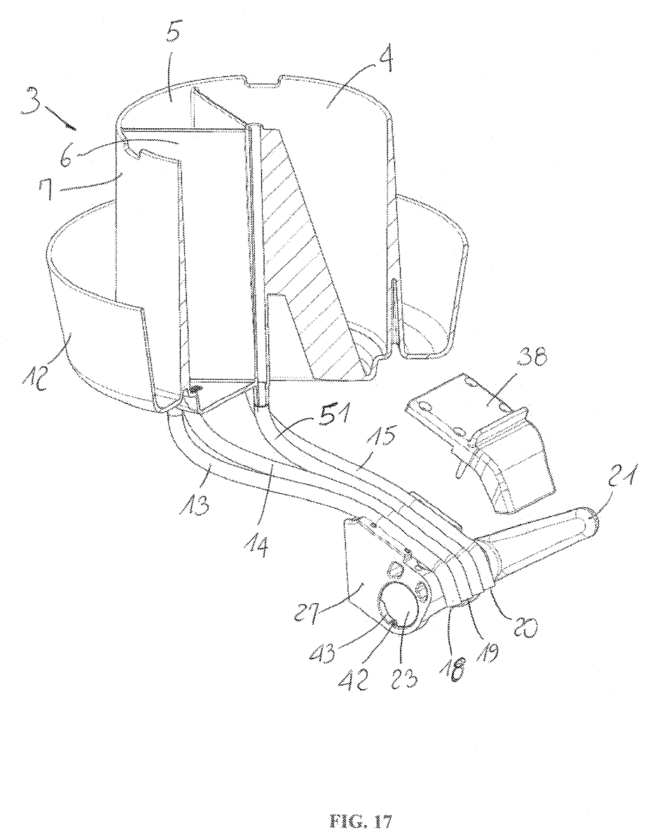

Furthermore, the shutters 47, 48 may be selected from a series of shutters having differentiated output sections, to allow the user to select those most suited to the recipe. Moreover, it will also be possible to use a single shutter or three shutters 47, 48, 49, as shown in FIG. 16, to regulate the flow exiting all three delivery ducts 13, 14, 15.

The shutters 47, 48, 49 may be used both in association with an actuator 16 of the type described above and shown in FIGS. 7 and 8 and in association with an actuator 16 having a single profile cam. In the latter case the regulation of each flow will be determined exclusively by the output section of the shutters 47, 48, 49.

FIG. 16 shows a second variant of the device 1 which differs from the previous ones primarily in that it comprises means for hermetically closing the reservoirs 4, 5, 6.

In particular, the hermetic closing means comprise a circular gasket 50 abutting the upper lid 11.

The presence of hermetic closing means allows for the creation of a sort of vacuum which allows the sparkling liquids not to lose carbon dioxide.

To avoid flow interruption due to vacuum at the time of dispensing, it will be necessary to introduce air into the reservoirs 4, 5, 6.

For this reason, an air intake duct 51 is provided, more clearly visible from FIG. 16, open at both ends to place one or more reservoirs 4, 5, 6 in fluid connection with the outside for the entry of air to their inside at every dispensing of the liquid.

The addition of the fourth duct 51, preferably made of silicone, makes it necessary to modify the support block 27 which must be provided with a fourth through hole and relative piston.

The actuator 16 will also have to be modified, to have a cylindrical body 23 with a greater axial length to engage the four pistons.

Operationally, after having at least partially filled the reservoirs 4, 5, 6 with the respective liquids, a glass or other container will be positioned at the outlet sections of the delivery ducts 13, 14, 15.

The actuator 16 will initially be arranged in such a way that the cams 24, 25, 26 compress locally, for example by means of the pistons 32, 33, 34, the respective delivery ducts 13, 14, 15, creating bottlenecks that prevent the leakage of liquids.

At this point, the lever 31 of the actuator 16 will be activated, making it rotate in one of the two directions so as to gradually reduce the compression effort and allow the gradual expansion of the sections of the delivery ducts 13, 14, 15 which will pass from a closed condition to a maximum open condition with consequent escape of liquids by gravity, which will not necessarily be simultaneous but which will depend on the configuration of the cams, designed depending on the drink to be prepared.

The mixing of the liquids and the composition of the drink will therefore take place directly in the glass.

From the above, it can be seen that the device according to the present invention achieves the intended objects.

1. A device for dispensing drinks, in particular drinks or cocktails, comprising:
a supporting base (2) adapted to be positioned on a support surface;
reservoirs (4, 5, 6) suitable for containing respective liquids to be used for the composition of the drink;
dispensing means for dispensing liquids from each of said reservoirs (4, 5, 6), said dispensing means being adapted to allow the dispensing of respective predetermined amounts of liquids from each of said reservoirs (4, 5, 6);
wherein said dispensing means comprise for each of said reservoirs (4, 5, 6) respective delivery ducts (13, 14, 15) of the corresponding liquid having a respective outlets (18, 19, 20) with predetermined section for the corresponding flow liquid;
wherein said dispensing means further comprises adjusting means for adjusting the flow rate of liquid exiting from each of said delivery ducts (13, 14, 15) suitable for allowing separate regulation of the flow exiting from each of said delivery ducts (13, 14, 15).

2. The device as claimed in claim 1, wherein said delivery ducts (13, 14, 15) are made of a deformable material, said adjusting means comprising an actuator (16) suitable for acting on said delivery ducts (13, 14, 15) to locally vary their section between a condition of throttling or complete closure and a condition of maximum opening to control the delivery of liquids therefrom.

3. The device as claimed in claim 2, wherein said actuator (16) comprises an operating lever (21) integral with a cylindrical body (23) on which a plurality of cams (24, 25, 26) in number equal to that of said delivery ducts (13, 14, 15) are made, said cams (24, 25, 26) having respective compression surfaces suitable to operate on respective delivery ducts (13, 14, 15).

4. The device as claimed in claim 3, wherein said cams (24, 25, 26) are monolithic with each other to operate, directly or indirectly, each on a respective of said delivery ducts (13, 14, 15) and locally vary their section upon the axial rotation imposed on said cylindrical body (23) by said operating lever (21) around the central axis (A) of said cylindrical body (23).

5. The device as claimed in claim 4, wherein said cams (24, 25, 26) have respective external profiles with curved compression surfaces having curvature radii differentiated from each other.

6. The device as claimed in claim 4, wherein two or more of said cams (24, 25, 26) have respective outer profiles with curved compression surfaces having the same radius of curvature.

7. The device as claimed in claim 3, wherein said dispensing means comprise a support block (27) having a cylindrical housing (28) for said cylindrical body (23) and said cams (24, 25, 26).

8. The device as claimed in claim 7, wherein said support block (27) has, for each of said cams (24, 25, 26), a corresponding through hole (35, 36, 37) facing the respective of said cams (24, 25, 26) and having a direction substantially orthogonal to said central rotation axis (A), each of said through holes (29, 30, 31) housing a respective piston (32, 33, 34) sized to protrude at least partially from the respective through hole (35, 36, 37) and engage with one end a respective of said cams (24, 25, 26) and with the other end a corresponding one of said delivery ducts (13, 14, 15) and locally vary the flow passage section.

9. The device as claimed in claim 1, wherein said adjusting means comprise for one or more of said delivery ducts (13, 14, 15) respective flow shutters suitable for locally varying the liquid passage section.

10. The device as claimed in claim 9, wherein said shutters 49) are adapted to be removably inserted at the outlet (18, 19, 20) of the corresponding of said delivery ducts (13, 14, 15) to reduce said section.

11. The device as claimed in claim 9 wherein said shutters 48, are selected into a group of shutters having output sections differentiated from each other.

12. The device as claimed in claim 1, comprising means for hermetically closing said reservoirs (4, 5, 6).

13. The device as claimed in claim 12, comprising an air intake duct (51) open at both ends to place one or more of said reservoirs 5, 6) in fluidic connection with the outside for the entry of air thereinside.

14. The device as claimed in claim 1, wherein said reservoirs (4, 5, 6) are integral with each other and contained in a common container (7) placed on the top of said supporting base (2).

15. The device as claimed in claim 14, wherein said common container (7) is removably fixed to said supporting base (2).

16. The device as claimed in claim 15, wherein said common container (7) is housed, possibly removably, in a base container (12) open at the top to allow the insertion of ice or other cooling material.

17. The device as claimed in claim 16, wherein said reservoirs 5, 6) have a height higher than the minimum height of said base container (12) and preferably the same height between them, said common container (7) also being provided with a removable upper closing lid (11) sized to keep said base container (12) at least partially accessible.
